(19) United States
(12) Patent Application Publication
(10) Pub. No.: US 2010/0052276 A1
(43) Pub. Date: Mar. 4, 2010

(54) ROLLING TOOL CART

(75) Inventor: Yaron Brunner, Timrat (IL)

Correspondence Address: OLIFF & BERRIDGE, PLC, P.O. BOX 320850, ALEXANDRIA, VA, 22320-4850, US

(73) Assignee: KETER PLASTIC LTD., Herzelyia (IL)

(21) Appl. No.: 12/523,594

(22) PCT Filed: Jan. 21, 2008
(86) PCT No.: PCT/IL08/00090

§ 371 Date: Oct. 23, 2009

Related U.S. Application Data
(60) Provisional application No. 60/881,488, filed on Jan. 22, 2007.

(51) Int. Cl. B62B 1/24; B25H 3/00; B65D 21/02

(52) U.S. Cl. 280/47.35; 220/4.27; 220/23.86

(57) ABSTRACT

A portable containers assembly comprising a base cabinet in the form of a bucket having an upper end and a top case assembly comprising at least one top cabinet. The top cabinet is slidably secured to the base cabinet. The top cabinet is slidable between a closed position in which it substantially covers the upper end of the base cabinet, and an open position in which it exposes the base cabinet. The portable containers assembly further comprising a locomotive assembly having a wheeling assembly and a handle assembly for locomoting the portable containers assembly.

### FIELD OF THE INVENTION

The present invention relates to rolling tool carts adapted for carrying and storing tools and whatever other articles, and more particularly to a portable cart of the type comprising at least two cabinets fitted with a locomotion assembly.

### BACKGROUND OF THE INVENTION

When a worker is required to go to a work place which is not a workshop in that it lacks the tools and other articles needed by the worker to perform various tasks, then the worker must bring along to the work place whatever tools and articles he needs to do the job he is expected to carry out, thereby converting the unequipped work place into a workshop.

In those cases where the tools and other articles the worker requires for the job at the work place can be stored in a tool box, then the worker can hand carry the tool box to the work place and then, in effect, transform it to a workshop. But more often than not, what the worker needs to bring to the work place cannot be fully accommodated even in an exceptionally large-capacity tool box.

To make it possible to wheel to a workplace a container capable of storing not only tools but whatever other articles are necessary to carry out the job to be performed at the work place, it is known to provide for this purpose a portable, wheeled container.

One such “Rolling Container Assembly” is disclosed in the European Patent EP 0933170B1 to Tirami et al. This assembly comprises rolling containers assembly including (a) a base cabinet including wheels and a pulling handle for locomoting the rolling containers assembly; and (b) at least one additional cabinet being removably connectable on top of the base cabinet.

Another container assembly is disclosed in U.S. Pat. No. 6,371,320 to Sagol, directed to a portable workshop container assembly adapted to store tools and other articles a worker requires to perform various tasks at a workplace. The assembly includes three major components in stacked relation. The lower component is a wheeled bucket, the middle component is a tray nested in the bucket and provided with a rim, and the third component is a tool box that rests on the rim. Also provided is a latching mechanism having a latch which is pivoted by a toggle member to the upper end of the bucket and cooperates with a first catch element mounted at the bottom of the tool box and a second catch element mounted on the rim of the tray. When the tool box rests on the rim, the first and second catch elements are then adjacent each other. In one mode of operation, the latch simultaneously engages the first and second latch elements to interlock all three components to form a unitary assembly that can be wheeled to the work place.

Still a portable container assembly is disclosed in U.S. Pat. No. 6,454,293 to Anderson, directed to a transport cart for medical-related supplies for transporting heavy chemotherapy treatment bags from the doctor's office to the home. The transport cart for medical-related supplies includes a lower support assembly including a base frame, and also including wheels being mounted upon the base frame, and further including an upright frame being securely attached to the base frame and extending upwardly therefrom; and also includes an upper support assembly including a support frame being pivotally attached to the upright frame; and further includes a first container assembly being securely mounted upon the lower support assembly; and also includes a second container assembly being securely attached to the upper support assembly.

When a container assembly is heavily loaded, and in particular an elevated container (namely above a lowermost container) it may be a difficult task to remove by lifting same so as to expose the contents of the lowermost container.

### SUMMARY OF THE INVENTION

The present invention provides a rolling tool cart assembly comprising a bucket-type base cabinet to which is articulated a top cabinet being displaceable with respect thereto between a closed position wherein the base container is substantially closed by a base portion of the top container, and an open position wherein the top container is displaced so as to expose the contents of the base cabinet and allow access thereto. The assembly further comprises wheels and a handle assembly for locomoting same.

The structure of the cart provides full access to the cabinets without having to detach the bucket-like cabinets from one another. In some embodiments of the invention, once the cart is tilted over its rear wheels, the base cabinet and any one or more top cabinets will spontaneously slide into the closed position.

According to the invention there is provided a portable containers assembly comprising a base cabinet in the form of a bucket having an upper end with a top cabinet articulated to the base cabinet and slidable between a closed position in which it substantially covers said upper end, and an open position in which it exposes the base cabinet; a wheeling assembly and a handle assembly for locomoting the portable containers assembly.

According to one embodiment of the invention the top cabinet is articulated to the base cabinet via a sliding mechanism comprising a first slide member fixed to a side edge of one of said base cabinet and said top cabinet and a second slide member fixed to a corresponding side edge of an other one of said base cabinet and said top cabinet, said first and second slide members being slidingly secured to one another such that the top cover slides substantially parallel with respect to said base cabinet.

According to another embodiment the top cabinet is articulated to the base cabinet via a parallelogram mechanism, comprising a pair of pivot links at opposite edges of the base cabinet and top cabinet, respectively.

The invention is thus concerned with a portable containers assembly comprising:
(a) a base cabinet in the form of a bucket having an upper end;
(b) a top case assembly comprising at least one top cabinet, and slidably secured to the base cabinet and slidable between a closed position in which it substantially covers said upper end, and an open position in which it exposes the base cabinet; and
(c) a locomotive assembly comprising a wheeling assembly and a handle assembly for locomoting the portable containers assembly.
   In some exemplary embodiments of the invention, there is provided a portable containers assembly includes:
(a) a base cabinet in the form of a bucket having an upper end;
(b) a top case assembly includes at least one top cabinet, and slidably secured to the base cabinet and slidable between a closed position in which it substantially covers the upper end, and an open position in which it exposes the base cabinet; and
(c) a locomotive assembly includes a wheeling assembly and a handle assembly for locomoting the portable containers assembly.

Optionally, the assembly further includes at least one support leg for supporting the top case assembly at the open position.

Optionally, the at least one support leg extends from a rear wall of the top case assembly and extends, at the open position thereof, to a surface supporting the portable containers assembly.

Optionally, the handle assembly is deployable between at least a locomoting position and a ground support position in which it constitutes the support leg assembly.

Optionally, the assembly further includes at least one tray nested in the base cabinet.

Optionally, the assembly further includes at least one tray nested in at least one of the at least one top cabinet.

Optionally, the top case assembly includes a tilt type cabinet.

Optionally, the top cabinet has an openable cover articulated thereto and a latch for securing the cover to the top cabinet when closed.

Optionally, the top case assembly further includes at least one second compartment.

Optionally, the at least one second compartment is articulated to the at least one top cabinet via a parallelogram mechanism.

Optionally, the at least one arm of the parallelogram mechanism connects the at least one second compartment and the base cabinet.

Optionally, the portable containers assembly includes a latch assembly for locking engagement of the base cabinet and the top case assembly.

Optionally, the portable containers assembly includes a latch assembly for locking engagement of the base cabinet and the top case assembly and the at least one second compartment.

Optionally, the base cabinet includes at a bottom portion thereof a foot step which when stepped on engages a ground surface supporting the portable containers assembly.

Optionally, the wheeling assembly includes at least a pair of wheels fitted to the base cabinet.

Optionally, the wheeling assembly includes at least two wheels and one swiveled wheel, whereby the portable containers assembly can be pushed/pulled at a substantially erect position.

Optionally, the wheeling assembly includes at least a pair of wheels fitted to the at least one support leg.

Optionally, the wheeling assembly further includes at least one swiveling wheel.

Optionally, the wheeling assembly includes at least a pair of wheels fitted to a support leg extending from the top case assembly.

Optionally, the handle assembly is fitted at a rear side of the top case assembly.

Optionally, the handle assembly is extendible between a stowed position and a locomoting position.

Optionally, the top case assembly includes a second cabinet slidingly articulated to a first top cabinet, the second cabinet slidable between a closed position in which it substantially covers a top edge of the first cabinet end, and an open position in which it exposes it.

Optionally, the top case assembly includes a second cabinet slidingly articulated to a first top cabinet, the second cabinet slidable between a closed position in which it substantially covers a top edge of the first cabinet end, and an open position in which it exposes it.

Optionally, the top cabinet is articulated to the base cabinet via a sliding mechanism includes a first slide member fixed to a side edge of one of the base cabinet and the top cabinet and a second slide member fixed to a corresponding side edge of an other one of the base cabinet and the top cabinet, the first and second slide members being slidingly secured to one another such that the top cover slides substantially parallel with respect to the base cabinet.

In some exemplary embodiments of the invention, there is provided a portable containers assembly includes a base cabinet in the form of a bucket having an upper end with a top cabinet articulated to the base cabinet and movable between a closed position in which it substantially covers the upper end, and an open position in which it exposes the base cabinet; a wheeling assembly and a handle assembly for locomoting the portable containers assembly.

Optionally, the top cabinet is articulated to the base cabinet via a sliding mechanism includes a first slide member fixed to a side edge of one of the base cabinet and the top cabinet and a second slide member fixed to a corresponding side edge of an other one of the base cabinet and the top cabinet, the first and second slide members being slidingly secured to one another such that the top cover slides substantially parallel with respect to the base cabinet.

Optionally, the top cabinet is articulated to the base cabinet via a parallelogram mechanism, includes a pair of pivot links at opposite edges of the: base cabinet and top cabinet, respectively.

Optionally, the assembly further includes at least one support leg for supporting the top cabinet at the open position.

Optionally, the at least one support leg extends from a rear wall of the top cabinet and extends, at the open position thereof, to a surface supporting the portable containers assembly.

In some exemplary embodiments of the invention, there is provided a portable containers assembly includes:
(a) at least three containers, each of the containers includes sides, a bottom and an open upper face;
(b) a locomotive assembly includes a wheeling assembly and a handle assembly for locomoting the portable containers assembly;
(c) an operating mechanism adapted to reversibly alter an arrangement of the containers between:
   a closed configuration in which the bottom of a first container covers the open upper face of an adjacent second container below the first container; and
   an open configuration in which the open upper face of each of the containers is not covered by a bottom of any other container.

Optionally, the operating mechanism includes a sliding mechanism includes a first slide member fixed to a side edge of one of the containers and a second slide member fixed to a corresponding side edge of an adjacent container, the first and second slide members being slidingly secured to one another.

Optionally, the operating mechanism includes at least two parallel arms, each of the arms pivotally attached to at least two of the at least three containers.

Optionally, at least one of the parallel arms is pivotally attached to at least two non-adjacent containers.

Optionally, at least one of the parallel arms is adapted for axial translation with respect to at least one point of pivotal attachment.

Optionally, the operating mechanism includes at least one pair of toothed drive wheels and a drive belt connecting a first wheel of the pair to a second wheel of the pair;

wherein axial motion of a first of the at least three containers causes teeth thereon to engage complementary teeth on the first wheel which translates the axial motion of the first container to rotational motion of the first wheel which is further translated to axial motion of the drive belt which is further translated to rotational motion of the second wheel.

Optionally, the operating mechanism includes:

a first operating mechanism adapted to alter an arrangement of a first subset of the containers between the closed and the open configurations; and

a second operating mechanism adapted to alter an arrangement of a second subset of the containers between the closed and the open configurations.

Optionally, the operating mechanism includes a first operating mechanism and a second operating mechanism adapted to cooperatively alter an arrangement of at least two of the containers between the closed and the open configurations.

Optionally, the portable containers assembly includes at least one support leg adapted to support at least, one of the containers in an open position.

Optionally, the portable containers assembly includes an openable cover adapted to cover the open upper face of an uppermost of the containers to which the cover is articulated.

Optionally, the portable containers assembly includes at least one removable tray adapted to reside in at least one of the containers.

In some exemplary embodiments of the invention, there is provided a container assembly, the assembly includes:

a base container having an upper opening;

an upper container mounted in covering relation over the upper opening of the base container;

a linkage connecting the upper container to the base container in a manner that allows the upper container to be displaced from the covering relation over the upper opening of the base container, so as to permit access into the base container through the upper opening;

a support assembly spaced from the base container when the upper container is displaced from the covering relation over the upper opening of the base container;

wheels disposed toward a lower portion of the container assembly; and

a handle for rollingly transporting the container assembly on the wheels in a tilted configuration.

Optionally, the assembly includes assembly a top container mounted in covering relation over the upper container, wherein the linkage is connected to the top container in a manner that allows the top container to be displaced from the covering relation over the upper container.

Optionally, a topmost of the containers has a pivotable cover that can be moved to cover and uncover an upper opening in the topmost container.

Optionally, the wheels are mounted on the support assembly.

Optionally, the wheels are mounted on the base container.

Optionally, the support assembly is operatively connected with the upper container so as to be automatically moved from a position adjacent to the base container to the position spaced from the base container when the upper container is displaced from the covering relation over the upper opening of the base container.

Optionally, a topmost of the containers has a top cover pivotally mounted for opening and closing.

Optionally, the pivotable cover has an opening stop surface that engages a cooperating stop surface on the top container when the cover is pivoted to an open position, so that when pivoted to an open position, the cover is disposed in a horizontal, cantilevered position.

In some exemplary embodiments of the invention, there is provided a portable containers assembly includes:
(d) a base cabinet in the form of a bucket having an upper end;
(e) a top case assembly includes at least one top cabinet, and slidably secured to the base cabinet and slidable between a closed position in which it substantially covers the upper end, and an open position in which it exposes the base cabinet; and
(f) a locomotive assembly includes a wheeling assembly and a handle assembly for locomoting the portable containers assembly.

Optionally, the assembly further includes at least one support leg for supporting the top case assembly at the open position.

Optionally, the at least one support leg extends from a rear wall of the top case assembly and extends, at the open position thereof, to a surface supporting the portable containers assembly.

Optionally, the handle assembly is deployable between at least a locomoting position and a ground support position in which it constitutes the support leg assembly.

Optionally, the assembly further includes at least one tray nested in the base cabinet.

Optionally, the top case assembly includes a tilt type cabinet.

Optionally, the top cabinet has an openable cover articulated thereto and a latch for securing the cover to the top cabinet when closed.

Optionally, the top case assembly further includes at least one second compartment.

Optionally, the at least one second compartment is articulated to the at least one top cabinet via a parallelogram mechanism.

Optionally, the at least one arm of the parallelogram mechanism connects the at least one second compartment and the base cabinet.

Optionally, the portable containers assembly includes a latch assembly for locking engagement of the base cabinet and the top case assembly.

Optionally, the portable containers assembly includes a latch assembly for locking engagement of the base cabinet and the top case assembly and the at least one second compartment.

Optionally, the base cabinet includes at a bottom portion thereof a foot step which when stepped on engages a ground surface supporting the portable containers assembly.

Optionally, the wheeling assembly includes at least a pair of wheels fitted to the base cabinet.

Optionally, the wheeling assembly includes at least two wheels and one swiveled wheel, whereby the portable containers assembly can be pushed/pulled at a substantially erect position.

Optionally, the wheeling assembly includes at least a pair of wheels fitted to the at least one support leg.

Optionally, the wheeling assembly further includes at least one swiveling wheel.

Optionally, the wheeling assembly includes at least a pair of wheels fitted to a support leg extending from the top case assembly.

Optionally, the handle assembly is fitted at a tear side of the top case assembly.

Optionally, the handle assembly is extendible between a stowed position and a locomoting position.

Optionally, the top case assembly includes a second cabinet slidingly articulated to a first top cabinet, the second cabinet slidable between a closed position in which it substantially covers a top edge of the first cabinet end, and an open position in which it exposes it.

Optionally, the top case assembly includes a second cabinet slidingly articulated to a first top cabinet, the second cabinet slidable between a closed position in which it substantially covers a top edge of the first cabinet end, and an open position in which it exposes it.

Optionally, the top cabinet is articulated to the base cabinet via a sliding mechanism includes a first slide member fixed to a side edge of one of the base cabinet and the top cabinet and a second slide member fixed to a corresponding side edge of an other one of the base cabinet and the top cabinet, the first and second slide members being slidingly secured to one another such that the top cover slides substantially parallel with respect to the base cabinet.

In some exemplary embodiments of the invention, there is provided a portable containers assembly includes a base cabinet in the form of a bucket having an upper end with a top cabinet articulated to the base cabinet and movable between a closed position in which it substantially covers the upper end, and an open position in which it exposes the base cabinet; a wheeling assembly and a handle assembly for locomoting the portable containers assembly.

Optionally, the top cabinet is articulated to the base cabinet via a sliding mechanism includes a first slide member fixed to a side edge of one of the base cabinet and the top cabinet and a second slide member fixed to a corresponding side edge of an other one of the base cabinet and the top cabinet, the first and second slide members being slidingly secured to one another such that the top cover slides substantially parallel with respect to the base cabinet.

Optionally, the top cabinet is articulated to the base cabinet via a parallelogram mechanism, includes a pair of pivot links at opposite edges of the base cabinet and top cabinet, respectively.

Optionally, the assembly further includes at least one support leg for supporting the top cabinet at the open position.

Optionally, the at least one support leg extends from a rear wall of the top cabinet and extends, at the open position thereof, to a surface supporting the portable containers assembly.

In some exemplary embodiments of the invention, there is provided a portable containers assembly includes:
(a) at least three containers, each of the containers includes sides, a bottom and an open upper face;
(b) a locomotive assembly includes a wheeling assembly and a handle assembly for locomoting the portable containers assembly;
(c) an operating mechanism adapted to reversibly alter an arrangement of the containers between:
   a closed configuration in which the bottom of a first container covers the open upper face of an adjacent second container below the first container; and
   an open configuration in which the open upper face of each of the containers is not covered by a bottom of any other container.

Optionally, the operating mechanism includes a sliding mechanism includes a first slide member fixed to a side edge of one of the containers and a second slide member fixed to a corresponding side edge of an adjacent container, the first and second slide members being slidingly secured to one another.

Optionally, the operating mechanism includes at least two parallel arms, each of the arms pivotally attached to at least two of the at least three containers.

Optionally, at least one of the parallel arms is pivotally attached to at least two non-adjacent containers.

Optionally, at least one of the parallel arms is adapted for axial translation with respect to at least one point of pivotal attachment.

Optionally, the operating mechanism includes at least one pair of toothed drive wheels and a drive belt connecting a first wheel of the pair to a second wheel of the pair;

wherein axial motion of a first of the at least three containers causes teeth thereon to engage complementary teeth on the first wheel which translates the axial motion of the first container to rotational motion of the first wheel which is further translated to axial motion of the drive belt which is further translated to rotational motion of the second wheel.

Optionally, the operating mechanism includes:

a first operating mechanism adapted to alter an arrangement of a first subset of the containers between the closed and the open configurations; and

a second operating mechanism adapted to alter an arrangement of a second subset of the containers between the closed and the open configurations.

Optionally, the operating mechanism includes a first operating mechanism and a second operating mechanism adapted to cooperatively alter an arrangement of at least two of the containers between the closed and the open configurations.

Optionally, the portable containers assembly includes at least one support leg adapted to support at least one of the containers in an open position.

Optionally, the portable containers assembly includes an openable cover adapted to cover the open upper face of an uppermost of the containers to which the cover is articulated.

Optionally, the portable containers assembly includes at least one removable tray adapted to reside in at least one of the containers.

In some exemplary embodiments of the invention, there is provided a container assembly, the assembly includes:

a base container having an upper opening;

an upper container mounted in covering relation over the upper opening of the base container;

a linkage connecting the upper container to the base container in a manner that allows the upper container to be displaced from the covering relation over the upper opening of the base container, so as to permit access into the base container through the upper opening;

a support assembly spaced from the base container when the upper container is displaced from the covering relation over the upper opening of the base container;

wheels disposed toward a lower portion of the container assembly; and

a handle for rollingly transporting the container assembly on the wheels in a tilted configuration.

Optionally, the assembly includes assembly a top container mounted in covering relation over the upper container, wherein the linkage is connected to the top container in a manner that allows the top container to be displaced from the covering relation over the upper container.

Optionally, a topmost of the containers has a pivotable cover that can be moved to cover and uncover an upper opening in the topmost container.

Optionally, the wheels are mounted on the support assembly.

Optionally, the wheels are mounted on the base container.

Optionally, the support assembly is operatively connected with the upper container so as to be automatically moved from a position adjacent to the base container to the position spaced from the base container when the upper container is displaced from the covering relation over the upper opening of the base container.

Optionally, a topmost of the containers has a top cover pivotally mounted for opening and closing.

Optionally, the pivotable cover has an opening stop surface that engages a cooperating stop surface on the top container when the cover is pivoted to an open position, so that when pivoted to an open position, the cover is disposed in a horizontal, cantilevered position.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

### BRIEF DESCRIPTION OF THE DRAWINGS

In order to understand the invention and to see how it may be carried out in practice, some embodiments will now be described, by way of non-limiting examples only, with reference to the accompanying drawings. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale.

The attached figures are:

FIG. 1 is a front perspective view of a cart according to a first embodiment of the present invention, the cart in its closed position and with a carrying handle at its extracted position;

FIG. 2 is a rear perspective view of the cart of FIG. 1;

FIG. 3 is a side view of the cart seen in the preceding figures;

FIG. 4 is an isometric view illustrating the cart of FIGS. 1-3 at an open position thereof;

FIG. 5 is a schematic side view of a cart according to another embodiment of the present invention, presented at a partially open position thereof;

FIG. 6 is a schematic side view of a cart according to yet another embodiment of the present invention, presented at a partially open position thereof;

FIG. 7 is a schematic section along line XII-XII in FIG. 5, illustrating a pedal-activated latching mechanism

FIGS. 8A and 8B schematically illustrate an embodiment of the present invention wherein the base cabinet and the top case assembly are pivotally articulated to one another by a parallel-type mechanism, wherein:

FIG. 8A illustrates the assembly at a closed position;

FIG. 8B illustrates the assembly at an open position;

FIGS. 9A, 9B, 9C and 9D are perspective views depicting an exemplary embodiment of the invention which employs a parallel-type mechanism and a slide mechanism in various operational states;

FIG. 9E is a cut away view depicting an exemplary operating mechanism for a foot operable latch according to some embodiments of the invention;

FIG. 10 is a perspective view of an additional exemplary embodiment of the invention in a closed operational state;

FIGS. 11A, 11B, and 11C are side views depicting an exemplary embodiment of the invention which employs a parallel-type mechanism and a slide mechanism in various operational states;

FIGS. 12A, 12B, and 12C are side views depicting an exemplary embodiment of the invention which employs a drive wheel mechanism in various operational states;

FIG. 13 is a more detailed side view and magnified inset depicting the drive mechanism of FIGS. 12A, 12B, and 12C in greater detail;

FIGS. 14A and 14B are side views depicting an exemplary embodiment of the invention which employs a handle to support a compartment of the cart when the compartment is in an open position;

FIGS. 15A, 15B, 15C and 15D are perspective views depicting an exemplary embodiment of the invention including an optional removable tray in various operational states;

FIGS. 16A, 16B, 16C are perspective views depicting an exemplary embodiment of the invention including an optional folding support brace in various operational states; and

FIG. 16D is a side view of an additional operational state of the embodiment depicted in FIGS. 16A, 16B, 16C.

### DETAILED DESCRIPTION OF EXEMPLARY EMBODIMENTS

Overview

Embodiments of the invention relate to portable containers. Many embodiments are configured as multi compartment carts. In some exemplary embodiments of the invention, two or more vertically aligned compartments are provided in a cart with wheels and a handle to facilitate transport. During use, the two or more compartments are horizontally displaced one with respect to another. This horizontal displacement contributes to accessibility of contents of the compartments. Optionally, increased accessibility to contents is achieved without destabilizing the cart. In some exemplary embodiments of the invention, the transition between the vertically aligned and the horizontally displaced configurations is easily achieved (e.g. one handed operation or foot pedal operation). According to different embodiments of the invention described hereinbelow, one or more mechanical mechanisms contribute to ease of achievement of this transition. Exemplary mechanical mechanisms include, but are not limited to, sliding mechanisms and parallel linked mechanisms.

Described embodiments of the invention can be used, for example, to store tools and/or supplies in an organized manner. The described multi compartment storage carts are expected to find utility in professions including, but not limited to, electrical installation and/or repair, plumbing, carpentry, painting and automobile mechanics.

The principles and operation of portable containers according to exemplary embodiments of the invention may be better understood with reference to the drawings and accompanying descriptions.

Before explaining at least one embodiment of the invention in detail, it is to be understood that the invention is not limited in its application to the details set forth in the following description. The invention is capable of other embodiments or of being practiced or carried out in various ways. Also, it is to be understood that the phraseology and terminology employed herein is for the purpose of description and should not be regarded as limiting.

Exemplary Sliding Mechanism

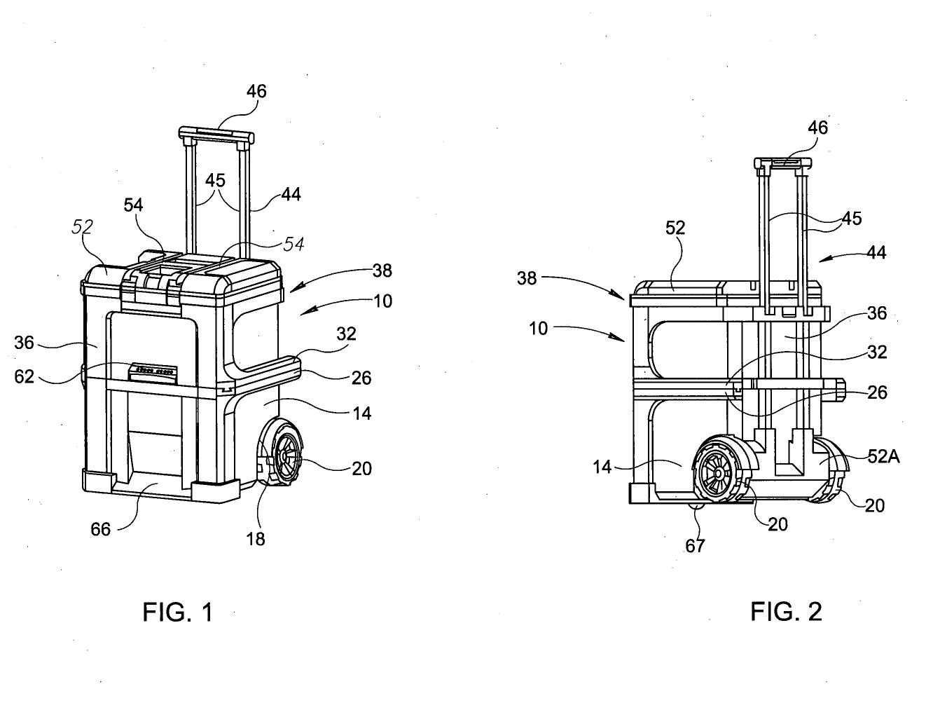

Attention is now directed to FIGS. 1 to 4 illustrating a first embodiment of a portable container's assembly in accordance with the present invention generally designated 10. The assembly comprises a base cabinet 14 in the form of a bucket, namely having an open top end as can be seen in FIG. 4. The word “bucket” as used herein refers to any container having an upper opening. The base cabinet 14 has at its side walls 16, at a rear end thereof a depression 18 sized for receiving a pair of wheels 20 as in the position of FIGS. 1 to 3. The top edge 24 of the side walls 16 is fitted with a first slide member 26 slidingly coupled with a mating second slide element 32 disposed at a bottom corresponding edge of a top cabinet 36. In the closed configuration of FIGS. 1, 2 and 3, assembly 10 con be brought to a tilted configuration and rolled like a standard two-wheeled hand truck.

The top cabinet 36 is part of a top case assembly generally designated 38 which in the embodiment of FIGS. 1 to 4 comprises only one cabinet (top cabinet 36). Top cabinet 36 can be described as an upper container mounted in covering relation over the upper opening of base cabinet 14 (or other base container).

The arrangement is such that the top case assembly 38 and more particularly in the embodiment of FIGS. 1 to 4 the top cabinet 36 is slidingly displaceable between a closed position as illustrated in FIGS. 1 to 3 wherein the top edge 24 of the bottom cabinet 14 is closed by a bottom of the top cabinet 36. However, displacing the top case assembly 38, namely the top cabinet 36 into its open position as in FIG. 4 exposes the contents of the bucket-like base cabinet 14.

It is appreciated that the base cabinet 14 and the top cabinet 36 are slidingly articulated to one another and remain attached at all times. However, for assembly and maintenance the first slide member 26 may be detached from the second slide member 32. Slide members 26 and 32 can be described as a linkage connecting top cabinet 36, or any upper container to base cabinet 14 (or other base container) in a manner that allows the upper container (e.g. top cabinet 36) to be displaced from the covering relation over the upper opening of the base container. Optionally, this displacement permits access into base container 14 through the upper opening.

As can further be seen in the drawings, the portable containers assembly 10 is fitted with a handle assembly 44 which in the present examples is articulated to the top cabinet 36 and is in the form of a telescopic handle comprising a hand grip 46 for locomoting the container's assembly 10 at its closed position (FIGS. 1 to 3) and further, as can be seen, the pair of wheels 20 extend at a bottom end of a support bracket 52A (FIGS. 2 and 4) downwardly extending from the top cabinet 36 to thereby support the container's assembly at its open position namely to support the top container 36 and prevent toppling over of the assembly. Handle assembly 44 and/or support bracket 52A can be described as a support assembly spaced from base container 14 when upper container 36 is displaced from the covering relation over the upper opening of base container 14. Wheels 20 are disposed toward a lower portion of container assembly 10.

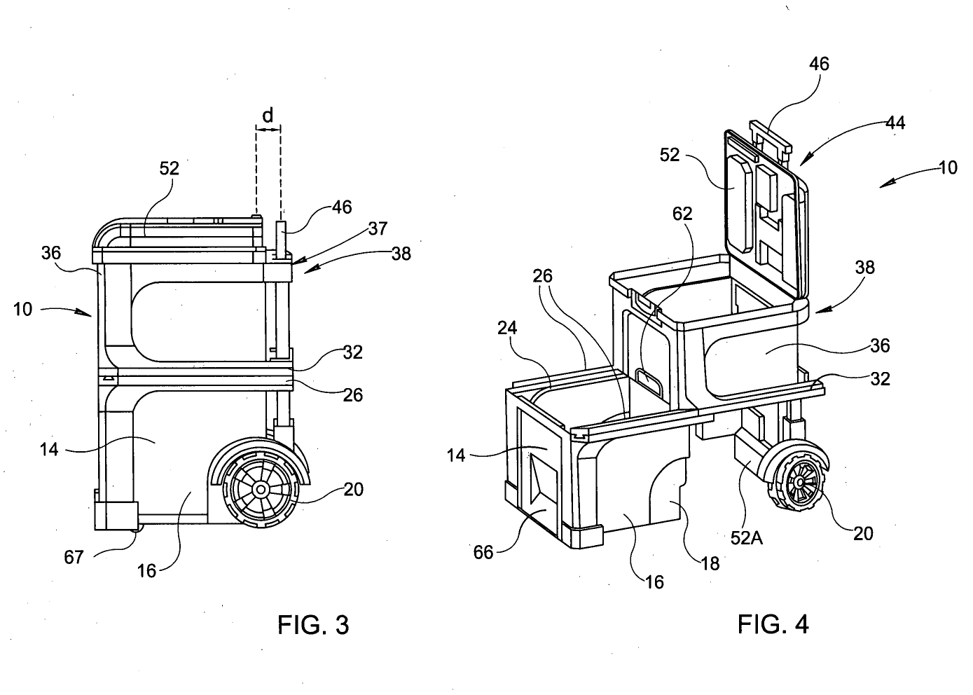

It is further noticed that the handle assembly 44 is retractable as in FIG. 3 to be compact in size. During use, hand grip 46 of handle assembly 44 serves for rollingly transporting container assembly 10 on wheels 20 in a tilted configuration.

The handle assembly 44 is also useful in retaining a cover 52 of the top container 36 at its open, substantially upright position as in FIG. 4. For that purpose, the cover 52 is fitted at its upper face with a pair of snap-type latches 54 (FIG. 1) for snapping engagement with the rails 45 of the handle assembly 44, as in FIG. 4. Displacing the top cover 52 into its closed position is merely by applying moderate force thereof in closing direction.

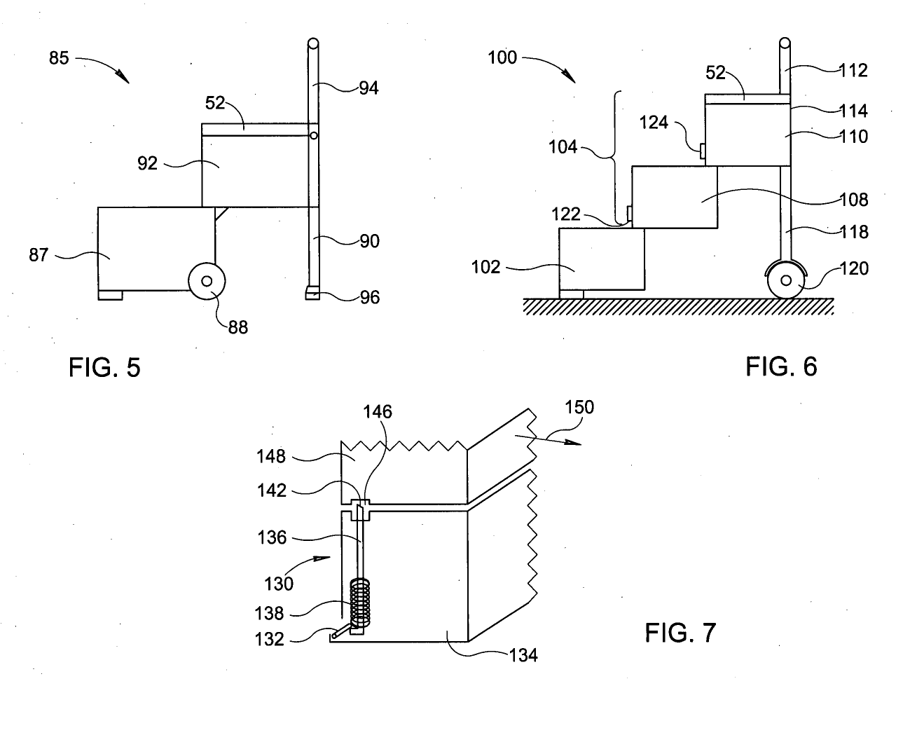

Cover 52 can be described as a pivotable cover that can be moved to cover and uncover an upper opening in top cabinet 36. FIGS. 5 and 6 make it clear that cover 52 can be mounted on an uppermost container, regardless of an actual number of containers in any specific embodiment of the invention.

The container's assembly 10 is fitted with a closure mechanism for securing the top cabinet 36 over the base cabinet 14 to prevent spontaneous opening thereof. For that purpose various latching arrangements may be provided. For example, the top cabinet 36 may be fitted with a latch 62 at its bottom front end for securing with the base cabinet 14. Alternatively, a closure assembly may be provided at the rails (first and second slide members 26 and 32). Furthermore, a locking arrangement may be provided to prevent unauthorized opening of the container's assembly e.g. by a throughgoing aperture extending through the rails 26 and 32 through which a padlock or locking pin may be inserted.

Furthermore, to facilitate opening the container's assembly 10 the base cabinet 14 is fitted with a footstep 66 whereby a user may apply pressure by his foot on said portion 66 to secure the base cabinet 14 while displacing the top case assembly 38 into its open position (FIG. 4).

One or more swivel wheels 67 are optionally fitted at a bottom of the base cabinet 14, typically adjacent its front end whereby the multiple wheeled arrangement comprising one or more swivel wheels 66 and the wheels 20 facilitates either pushing or pulling the portable container's assembly, also at its substantially upright position as in the figures or, at a pulling position inclined over an axis extending through the rear wheels 20.

Turning now to the embodiment of FIG. 5, there is illustrated a portable container's assembly generally designated 85, wherein the base cabinet 87 is fitted with a pair of rear wheels 88 and wherein a support leg 90 extends from the top cabinet 92, in continuation with the handle assembly 94. The arrangement is such that upon closing the portable container's assembly 85 (position not illustrated) the foot 96 of the support leg 90 extends between the rear wheels 88 and will not interfere with the general appearance of the portable containers assembly or with locomotion thereof.

In FIG. 6 there is illustrated a different embodiment of a portable container's assembly of the present invention generally designated 100 wherein a base cabinet 102 is shown resting on a ground surface and wherein a top case assembly generally designated 104 comprises a first cabinet 108 slidingly articulated over the base cabinet 102 and a second cabinet 110 slidingly articulated over the first cabinet 108, wherein a handle assembly 112 is articulated to the back wall 114 of the top cabinet 110 and a support leg 118 extends from the second, top cabinet 110 for engagement with the ground surface over a locomoting wheel assembly comprising at least two wheels 120.

The embodiment of FIG. 6 is such that displacing the first and second containers 108 and 110 respectively exposes the contents of the bucket-like cabinets 102 and 108 (as in the position of FIG. 6) whilst closing the container's assembly 100 entails closing of the bucket-like cabinets 102 and 108. It is also appreciated that the base cabinet 100 may be opened without necessarily opening the first cabinet 108 by appropriate releasing locking latches 122 and 124 respectively fitted on the first cabinet 108 and the second cabinet 110 as explained herein before.

Container 100 of FIG. 6 could also be described as container further including a top container 110 mounted in covering relation over upper container 108, wherein the linkage is connected to top container 110 in a manner that allows top container 110 to be displaced from the covering relation over upper container 108.

In the embodiment of FIG. 7 there is illustrated a latching mechanism generally designated 130 in accordance with a modification of the present embodiment. In accordance with this embodiment, the foot pedal 132 fitted at a front portion of a base cabinet 134 is adapted for depressing an extension rod 136 against the biasing sect of a coiled spring 138 thereby retracting it so its top edge 142 disengages from a locking edge 144 at a front bottom edge of a top cabinet 148. The arrangement is such that depressing pedal 132 entails downward displacement of rod 136 whereby the top cabinet 148 may be rearwardly slid in direction of 150.

As can be seen, the top edge of latch 142 is inclined such that the top cabinet 148 may be snappingly locked without having to depress foot engaging pedal 132.

This arrangement has the advantage that depressing the foot pedal 132 simultaneously arrests the base cabinet to prevent its displacement whilst slidingly open the top case assembly.

According to the invention, where the support leg extends from the top-most cabinet, when the container is in its open position and is slightly tilted over the rear support (foot 96 in the embodiment of FIG. 5; wheels 120 in the embodiment of FIG. 6) the base cabinet will spontaneously slidingly displace towards the closed position, collecting all the cabinets into the closed position. Where a self latching mechanism is provided, e.g. of the type illustrated in connection with the embodiment of FIG. 7, the cabinets will automatically engage into their closed and locked position.

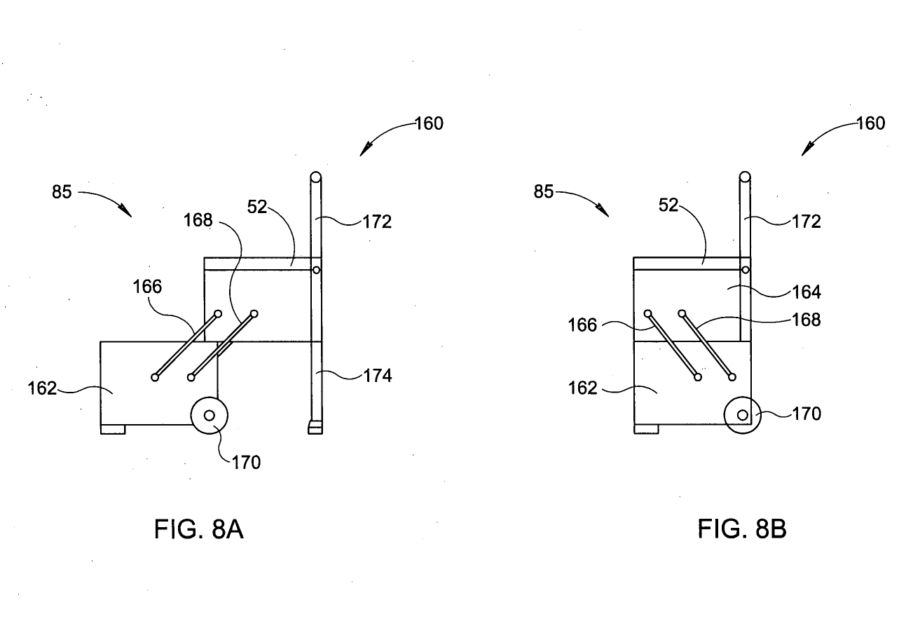

The embodiment of FIGS. 8A and 8B schematically illustrate a portable container's assembly in accordance with the present invention generally designated 160 wherein a base cabinet 162 is articulated to a top cabinet 164 by means of a pair of pivotable links 166 and 168 constituting a parallel-type mechanism whereby the top cabinet 164 may be cylindrically displaceable between a closed position (FIG. 8A) and an open position (FIG. 7B) however without detaching from the base cabinet 162. In this particular embodiment the base cabinet 162 is fitted with a pair of rear wheels 170 and the top cabinet 164 is fitted with a handle assembly 172 and support leg for engaging a support surface.

Pivotable links 166 and 168 can be described as a linkage connecting top cabinet 36, or any upper container to base cabinet 14 (or other base container) in a manner that allows the upper container (e.g. top cabinet 36) to be displaced from the covering relation over the upper opening of the base container. Optionally, this displacement permits access into base container 14 through the upper opening.

In some embodiments of the invention, pivotable links of the general type 166 and 168 are employed to govern displacement of top container 110 with respect to upper container 108 (FIG. 6). Optionally, a sliding mechanism or additional pivot mechanisms governs displacement of upper container 108 with respect to base container (cabinet 102).

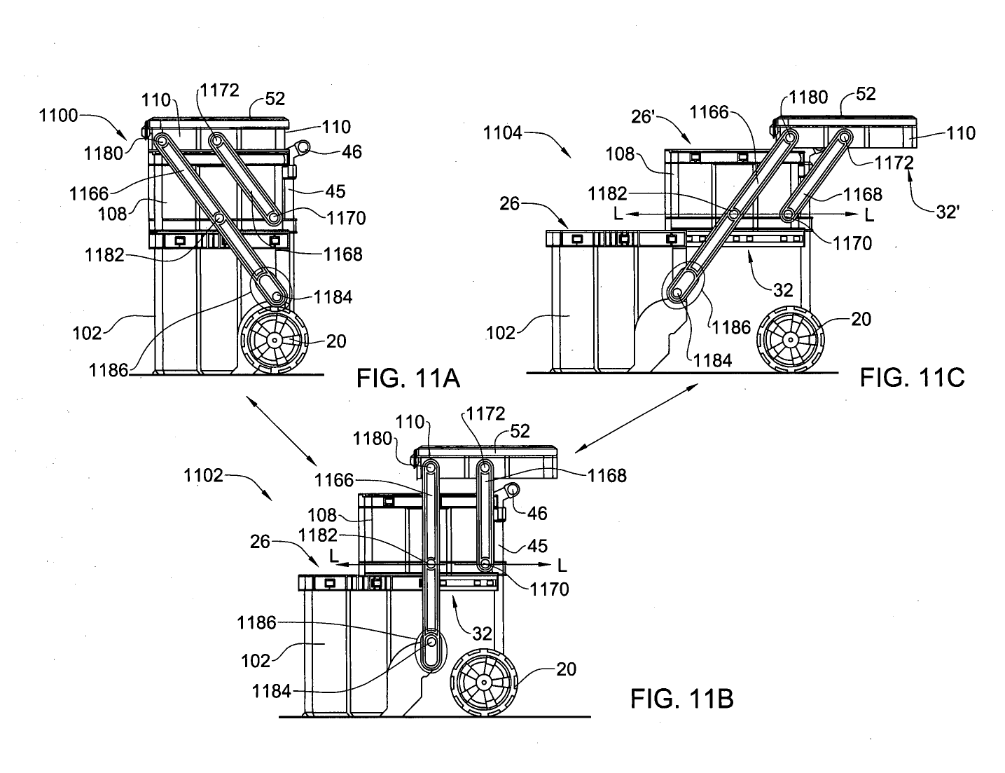

In other embodiments of the invention, a same set of pivotable links is employed to at least partially govern displacement of top container 110 with respect to upper container 108 and displacement of upper container 108 with respect to base container (cabinet 102) as described in greater detail hereinbelow with regard to FIGS. 11A, 11B and 11C. In cases where the same set of pivotable links connects three or more containers, a degree of axial translation is provided on those links which connect three or more containers at one or more of their attachment points. Means for providing this axial translation are well know to those of ordinary skill in the art and will easily be incorporated into parallel linked mechanisms according to exemplary embodiments of the invention. Optionally, a slide mechanism between upper container 108 and base container (cabinet 102) contributes to governing displacement thereof as part of a parallel linked mechanism.

Exemplary Cantilevered Shelf

Referring again to FIG. 3, in some exemplary embodiments of the invention, cover 52 of top cabinet 36 can serve as a cantilevered shelf. The letter “d” indicates a distance between handgrip 46 of handle assembly 44 and a rearmost edge of cover 52. In some exemplary embodiments of the invention, handgrip 46 is further lowered (e.g. to a level of an upper surface 37 of a top container (e.g. top cabinet 36 ) which provides a cooperating opening stop surface that engages an stop surface on a top of cover 52. When cover 42 is pivoted to a fully opened position, the stop surfaces contact one another and cover 52 is supported while disposed in a horizontal cantilevered position. Optionally, increasing d contributes to an increased degree of support for a cantilevered shelf formed by inverted cover 52.

Exemplary Dual Mechanism Embodiment

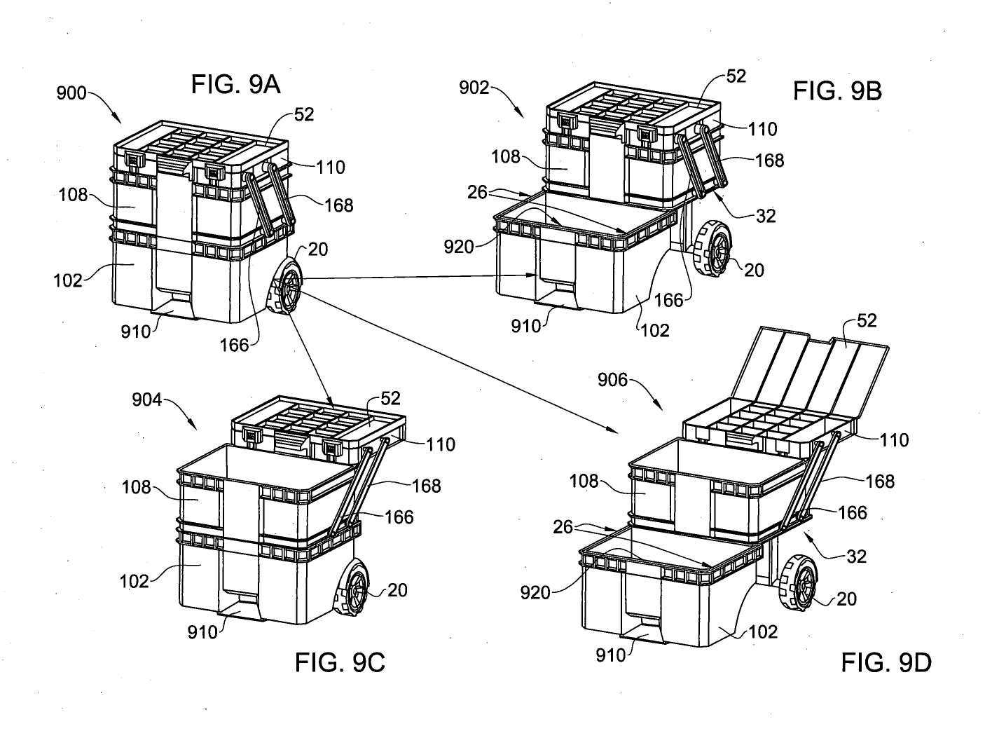

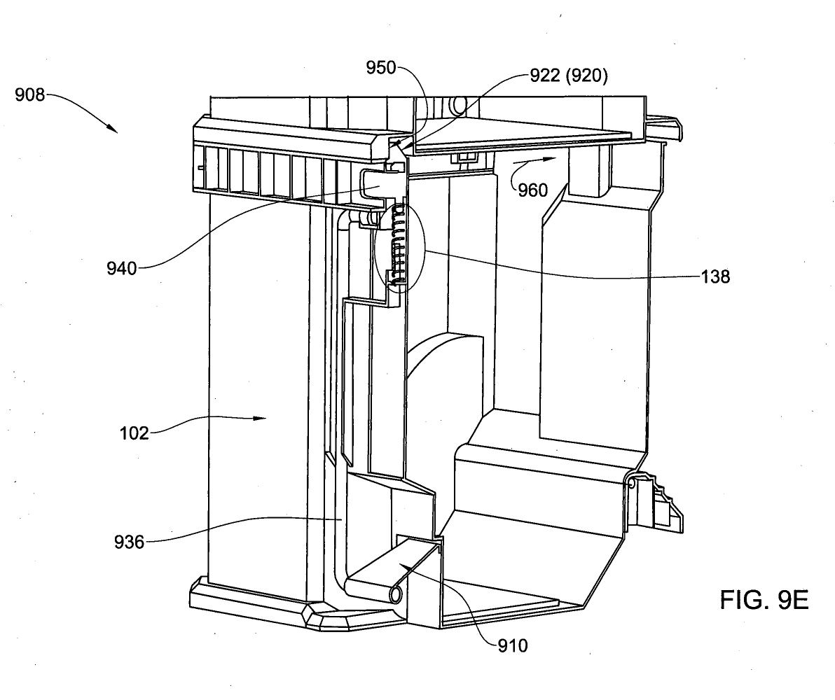

FIGS. 9A, 9B, 9C and 9D are perspective views depicting an exemplary embodiment of the invention which employs a parallel-type mechanism (166 and 168 as described hereinabove) and a slide mechanism (e.g. 26 and 32 as described hereinabove) in various operational states depicted generally as 900, 902, 904 and 906 respectively.

In the depicted embodiment, there are three cabinets, or containers, labeled (from top to bottom) 110, 108 and 102 as in FIG. 6.

Because parallel-type mechanism (depicted as 166 and 168) and slide mechanism (depicted as 26 and 32) are independently operable, cabinet 108 functions as a base cabinet with respect to parallel-type mechanism 166 and 168 and also functions as a top cabinet with respect to slide mechanism 26 and 32.

Cabinets 108 and 110 together serve as a top case assembly with respect to slide mechanism 26 and 32. In the depicted embodiment, the top case assembly includes two cases, although other embodiments with three, four, five or more cases are within the scope of the invention.

FIG. 9A depicts an exemplary cart with wheels 20 in a closed operational state 900. In closed operational state 900 cabinets 110, 108 and 102 are vertically aligned with one another. Optionally, each of the cabinets has a similar horizontal cross section so that vertical alignment causes each cabinet to cover an upper opening of the cabinet immediately below.

FIG. 9B depicts a partially open operational state 902 in which base cabinet 102 is horizontally displaced with respect to cabinets 108 and 110. In partially open state 902, an upper opening of cabinet 102 is uncovered so that an inner volume of cabinet 102 is accessible. In the depicted embodiment, operation of slide mechanism 26 and 32 allows transition from operational state 900 to operational state 902.

FIG. 9C depicts a partially open operational state 904 in which cabinet 110 is horizontally displaced with respect to cabinets 108 and 102. In partially open state 904, an upper opening of cabinet 108 is uncovered so that an inner volume of cabinet 108 is accessible. In the depicted embodiment, operation of parallel-type mechanism 166 and 168 allows transition from operational state 900 to operational state 904.

FIG. 9D depicts a fully open operational state 906 in which cabinet 102 is horizontally displaced with respect to cabinets 108 and 110 in a first direction and cabinet 110 is horizontally displaced with respect to cabinets 108 and 102 in a second direction.

In depicted fully open operational state 906, both upper opening of cabinet 102 and upper opening of cabinet 108 are uncovered so that inner volumes of the respective cabinets are accessible.

Hinged lid 52 is depicted as open in operational state 906 and closed in operational states 900, 902 and 904. This is solely for purposes of illustration. Hinged lid 52 can be open or closed in any of the depicted operational states since it operates independently of both parallel-type mechanism 166 and 168 and slide mechanism 26 and 32.

In the depicted embodiment, parallel-type mechanism 166 and 168 is shown governing horizontal displacement of cabinet 110 with respect to cabinet 108 and slide mechanism 26 and 32 is shown governing horizontal displacement of cabinet 102 with respect to cabinet 108. This configuration is purely illustrative and additional dual mechanism embodiments of the invention are based upon an opposite arrangement in which parallel-type mechanism 166 and 168 governs horizontal displacement of cabinet 108 with respect to cabinet 102 and slide mechanism 26 and 32 is shown governs horizontal displacement of cabinet 110 with respect to cabinet 108.

Exemplary Locking Mechanisms

In some exemplary embodiments of the invention, a locking mechanism prevents unintentional movement of one or more cabinets with respect to one or more other cabinets. Locking mechanisms are generally described hereinabove in the context of FIG. 7.

Referring again to FIGS. 9A, 9B, 9C and 9D some exemplary locking mechanisms employ a foot pedal 910. Foot pedal 910 is optionally analogous to pedal 132 of FIG. 7. Depicted exemplary foot pedal 910 is operably connected to a retractable latch 920 on an upper edge of cabinet 102. Exemplary operable connections are described above with regard to FIG. 7. In closed configuration 900, latch 920 is extended upward and engages a bottom surface of cabinet 108.

In some exemplary embodiments of the invention, a user depresses pedal 910 to retract latch 920. This makes it possible to move cabinet 102 with respect to cabinet 108 in order to achieve operational state 902 or 906.

FIG. 9E is a cut away view depicting an exemplary operating mechanism 908 for pedal 910 and latch 920.

In the depicted embodiment, foot pedal 910 is adapted for depressing an extension rod 936. Rod 936 lowers connecting member 936 against resistance provided by spring 138 and causes latch 920 to rotate with respect to axis 940. Rotation of latch 920 releases edge 950 of cabinet 108. The arrangement is such that depressing pedal 910 entails downward displacement of rod 936 whereby the cabinet 108 may be rearwardly slid in direction 960.

As can be seen, top edge 922 of latch 920 is inclined such that the cabinet 108 may be snappingly locked without having to depress pedal 910.

This arrangement has the advantage that depressing the pedal 910 simultaneously arrests cabinet 102 to prevent its displacement during opening.

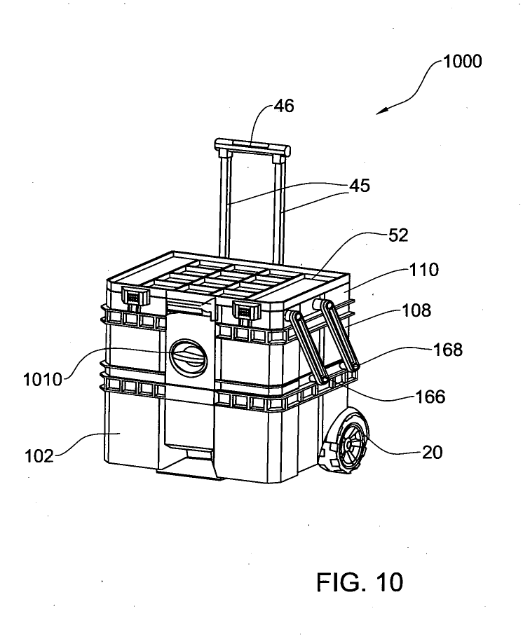

FIG. 10 is a perspective view of an additional exemplary embodiment of the invention in a closed operational state 1000. The depicted embodiment is similar to the embodiment of FIGS. 9A, 9B, 9C and 9D except that the locking mechanism is different. The depicted exemplary locking mechanism includes a single user operable interface depicted generally as rotatable dial 1010. In some exemplary embodiments of the invention, the single user operable interface controls at least two locking mechanisms. Two locking mechanisms are sufficient for a three cabinet embodiment. Additional locking mechanisms are optionally added as a number of cabinets increases.

Optionally, a first locking mechanism prevents horizontal translation of a first cabinet (e.g. 102) with respect to a second cabinet (e.g. 108) and a second locking mechanism prevents horizontal translation of a third cabinet (e.g. 110) with respect to the second cabinet (e.g. 108).

In some exemplary embodiments of the invention, the first and second locking mechanisms are independently operable.

In one example, rotation (e.g. clockwise) of rotatable dial 1010 through a predetermined angle (e.g. 45 degrees) releases the first locking mechanism and additional rotation (e.g. to a total of 90 degrees) releases the second locking mechanism.

In another example, rotation in a first direction (e.g. clockwise) of rotatable dial 1010 releases the first locking mechanism and rotation in a second direction (e.g. counterclockwise) releases the second locking mechanism.

One of ordinary skill in the art will be able to design and implement suitable locking mechanisms based upon a description of a desired behavior of a user operable interface without undue experimentation.

### Additional Exemplary Parallel Type Mechanism Embodiment

FIGS. 11A, 11B, and 11C are side views depicting an exemplary embodiment of the invention which employs a parallel-type mechanism (e.g. 1166 and 1168) in various operational states. Optionally, a slide mechanism (e.g. 26 and 32) is also employed.

A closed state 100 is depicted in FIG. 11A and an open state 1104 is depicted in FIG. 11C. FIG. 11B depicts a transitional state 1102.

Arrangement of cabinets 110, 108 and 102 in the closed and open operational states is analogous to that depicted in FIGS. 9A and 9D and described hereinabove.

In contrast to the exemplary embodiment of FIG. 9 arms 1168 and 1166 in the depicted embodiment are not of equal length. In some exemplary embodiments of the invention, coordinate operation of arms of unequal length contributes to concurrent horizontal displacement of cabinet 102 with respect to cabinets 108 and 110 in a first direction and horizontal displacement of cabinet 110 with respect to cabinets 108 and 102 in a second direction.

In the depicted embodiment a long arm 1166 is pivotally attached to cabinets 110, 108 and 102 at pivot points 1180, 1182 and 1184 respectively and short arm 1168 is pivotally attached to cabinets 110 and 108 at pivot points 1172 and 1170 respectively. Pivot points 1182 and 1170 are co-linear on horizontal line L-L. In the depicted embodiment, pivot point 1184 is capable of axial translation with respect to long arm 1166. The axial translation occurs within an axial slot 1186 provided in arm 1166.

In order to switch from closed state 1100 to open state 1104, a user applies one or more horizontal translational forces to one or more cabinets. Using the depicted exemplary orientation for purposes of illustration, a user might push cabinet 110 to the right (i.e. towards handle 46) and/or pull cabinet 102 away from wheels 20. It is pointed out that in closed state 1100 arms 1166 and 1168 are each tilted leftwards and that pivot point 1184 of arm 1166 is positioned distally in slot 1186 with respect to pivot point 1182.

In response to applied horizontal translational forces, arms 1166 and 1168 rotate clockwise with respect to pivot points 1182 and 1170 respectively. FIG. 11B depicts a transitional state in which arms 1166 and 1168 are vertical. At this stage cabinet 102 has been displaced to the left with respect to cabinet 108 and cabinet 110 has been both raised and displaced to the right with respect to cabinet 108. In the depicted embodiment, cabinet 110 remains level when it is raised. Optionally, axial translation of pivot point 1184 with respect to arm 1166 contributes to leveling of cabinet 110 during a transition from closed state 1100 to open state 1104. In transitional state 1102, pivot point 1184 has moved towards pivot point 1182 within slot 1186 in arm 1166.

In response to application of additional horizontal translational forces cabinet 102 is displaced further to the left with respect to cabinet 108 and cabinet 110 is lowered and displaced further to the right with respect to cabinet 108 until open state 1104 is reached. In open state 1104 arms 1166 and 1168 are each tilted rightwards and pivot point 1184 of arm 1166 is again positioned distally with respect to pivot point 1182 in slot 1186 as it was in closed state 1100.

In some exemplary embodiments of the invention, motion of cabinet 102 with respect to cabinet 108 is also governed by a sliding mechanism (e.g. 26 and 32) as described hereinabove.

In some exemplary embodiments of the invention, long arm 1166 is provided with only two pivot points 1184 and 1180 and slot 1186 is eliminated. According to these embodiments of the invention, as arm 1166 approaches the vertical position depicted in FIG. 11B, pivot point 1180 is higher than pivot point 1172 of short arm 1168 and cabinet 110 is rotated clockwise with respect to pivot point 1172.

Exemplary Drive Wheel Mechanism Embodiment

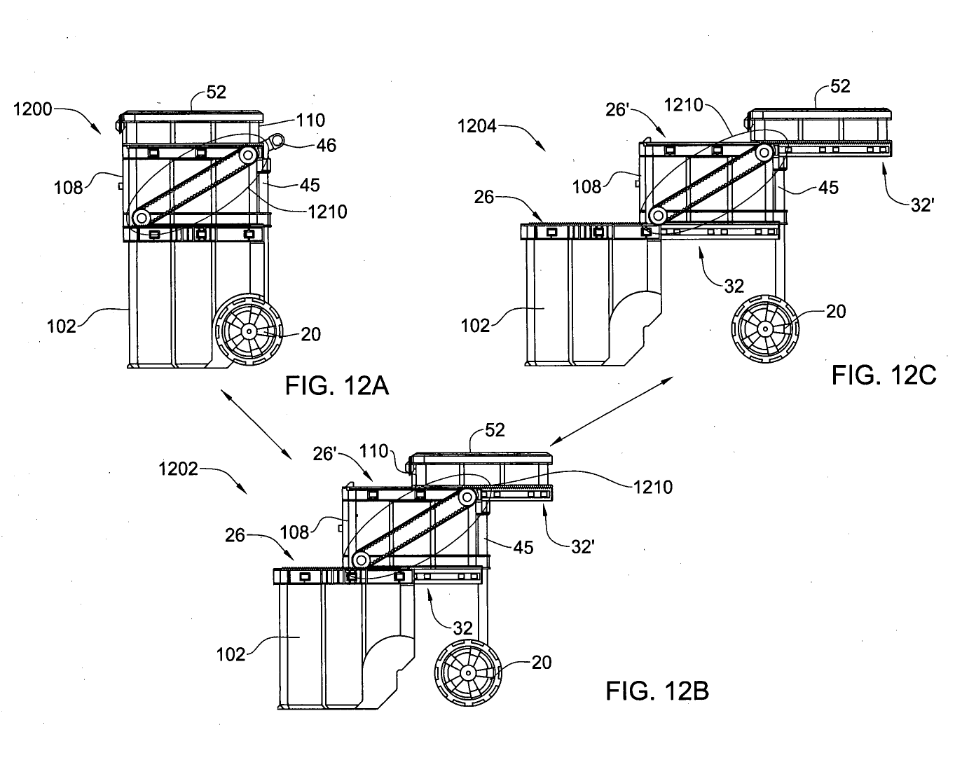

FIGS. 12A, 12B, and 12C are side views depicting an exemplary embodiment of the invention which employs a drive wheel mechanism 1210 to govern a degree of vertical alignment between exemplary cabinets 110, 108 and 102. Optionally, drive wheel mechanism operates in conjunction with one or more sliding mechanisms (e.g. 26 and 32 and/or 26′ and 32′) as described hereinabove.

FIG. 12A depicts a closed operational state 1200 in which cabinets 110, 108 and 102 are vertically aligned.

FIG. 12B depicts a partially open operational state 1202 in which cabinet 102 is partially horizontally displaced in a first direction with respect to cabinets 108 and 110 and cabinet 110 is partially horizontally displaced in a second direction with respect to cabinets 108 and 102.

FIG. 12C depicts an open operational state 1202 in which cabinet 102 is fully horizontally displaced in a first direction with respect to cabinets 108 and 110 and, cabinet 110 is fully horizontally displaced in a second direction with respect to cabinets 108 and 102.

In order to switch from closed state 1200 to open state 1104, a user applies one or more horizontal translational forces to one or more cabinets. Using the depicted exemplary orientation for purposes of illustration, a user might push cabinet 110 to the right (i.e. towards handle 46) and/or pull cabinet 102 away from wheels 20.

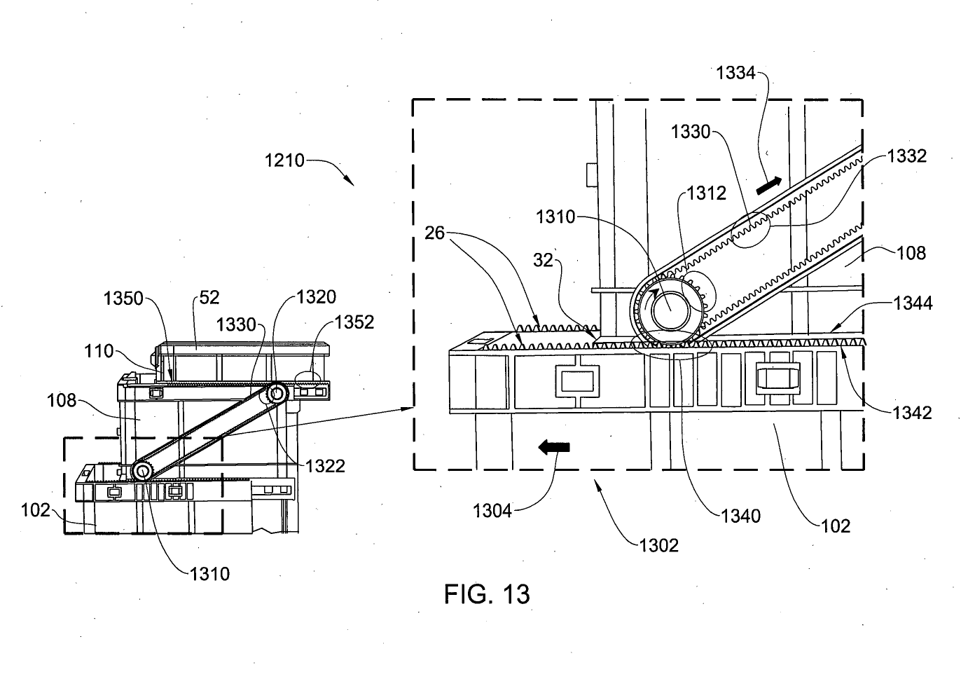

Referring now to inset 1302 of FIG. 13, application of a leftwards horizontal force (indicated by arrow 1304) to cabinet 102 causes cabinet 102 to be displaced t0 the left with respect to cabinet 108. Optionally, motion of cabinet 102 with respect to cabinet 106 is guided by sliding mechanism 26 and 32 as described hereinabove.

Motion of cabinet 102 with respect to cabinet 106 causes teeth 1340 deployed along an upper edge 1342 of cabinet 102 to successively pass beneath drive wheel 1310 where they engage complementary teeth 1312 circumferentially deployed on wheel 1310. Engagement of complementary teeth 1312 causes translation of linear motion of upper edge 1342 of cabinet 102 to rotational motion of wheel 1310 (clockwise as indicated by arrow). Wheel 1310 is wider (deeper in this side view) than teeth 1340 so that teeth 1312 of wheel 1310 also engage a third set of teeth 1332 provided on a drive belt 1330. Rotational motion of wheel 1310 is translated into axial motion of drive belt 1330 as indicated by arrow 1334.

Axial motion of drive belt 1130 causes teeth 1332 to engage teeth 1322 of drive wheel 1320 which translates the axial motion into rotational motion of wheel 1320. Wheel 1320, like wheel 1310 is wider (deeper in this side view) than teeth 1332 so that teeth 1322 of wheel 1320 also engage a fourth set of teeth 1352 provided on a lower edge 1350 of cabinet 110. Rotational motion of wheel 1320 is translated into axial motion of cabinet 110 in a direction opposite to that of cabinet 110 (to the right in the current example).

This mechanism allows transition from closed state 1200 via intermediate state 1202 to open state 1204. Optionally, the horizontal force can be applied as a rightwards horizontal force to cabinet 110 instead of, or in addition to, a leftwards force to cabinet 102.

In some exemplary embodiments of the invention, belt 1330 is replaced by a high friction band without teeth 1332.

In some exemplary embodiments of the invention, belt 1330 is replaced by a drive chain with links adapted to engage teeth 1312 and 1322 of drive wheels 1310 and 1320 respectively.

Exemplary use of a Handle as a Support

As described hereinabove with regard to FIG. 3, a handle (e.g. 46) can be used to support a portion of the cart.

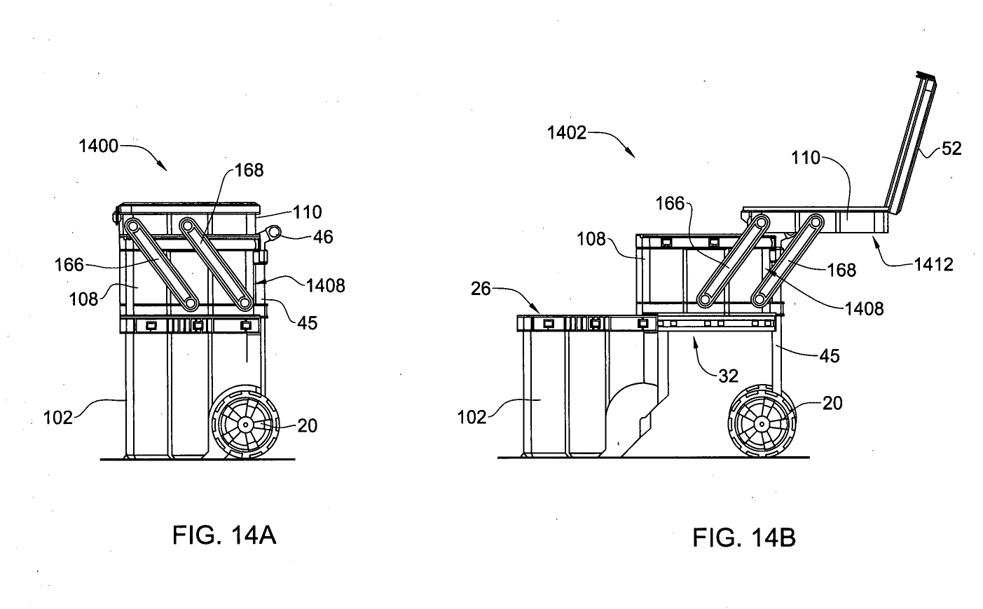

FIGS. 14A and 14B are side views depicting an exemplary embodiment of the invention in a closed operational state 1400 and an open operational state 1402 respectively. In the depicted embodiment, handle 46 is angled with respect to rails 45 which are connected to rear edge 1408 of cabinet 108 and supported by wheels 20. As seen in FIG. 14B, angled handle 46 contacts a bottom surface of cabinet 110 in open configuration 1402. Optionally, this contact provides support for cabinet 110. In some exemplary embodiments of the invention, a degree of support is increased by increasing an angle and/or a length of handle 46. In the depicted embodiment rear edge 1408 of cabinet 108 supports cabinet 110 in open configuration 1402. A maximum degree of support will is provided by handle 46 if it contacts cabinet 110 at rear edge 1412. A high degree of support is provided by handle 46 if it contacts cabinet 110 between rear edge 1412 and midline 1410. A lesser, but still significant degree of support is provided by handle 46 if it contacts cabinet 110 between midline 1410 and rails 45 as shown.

Exemplary Embodiment with Removable Tray

Embodiments described hereinabove include either two cabinets and one opening mechanism or three cabinets with two opening mechanisms or a single more complex opening mechanism. While there are advantages to the compartmentalization provided by three cabinets, implementation of two opening mechanisms or a single more complex opening mechanism can contribute to increased product cost and/or manufacturing complexity and/or complexity of use.

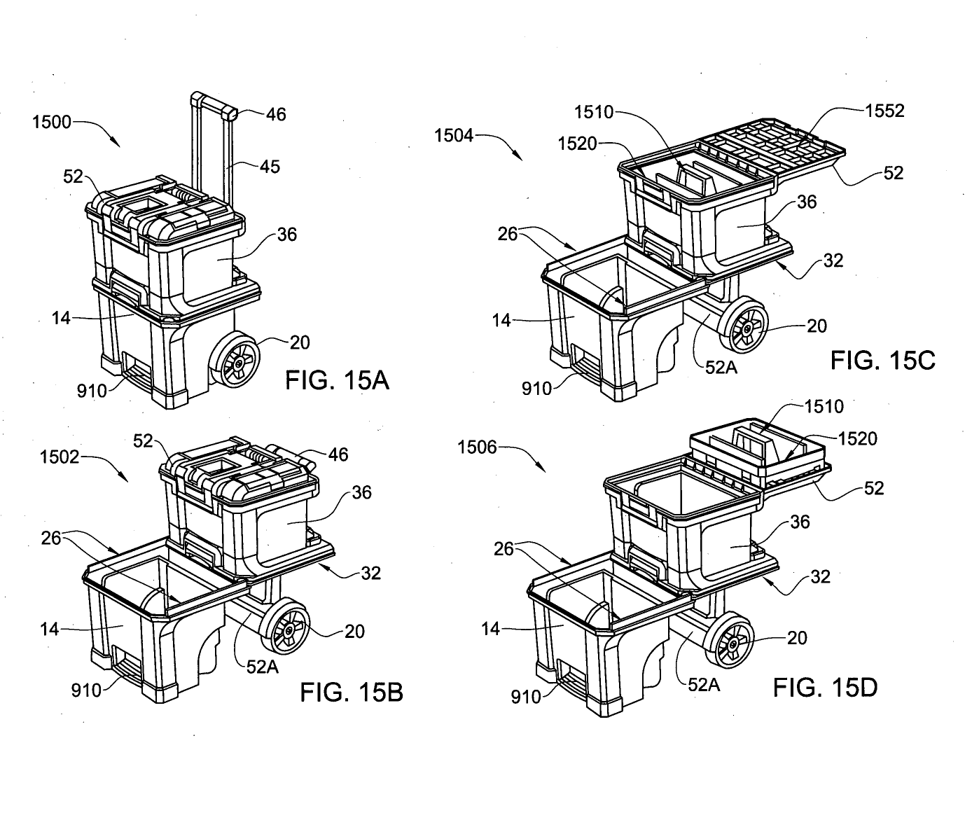

FIGS. 15A, 15B, 15C and 15D are perspective views depicting an exemplary embodiment of the invention which retains the compartmentalization advantages of three cabinet embodiments while employing one opening mechanism to control relative displacement of a base cabinet 14 with respect to a top cabinet 36. The depicted embodiment includes a removable tray 1520 with a carrying handle 1510. Tray 1520 provides many of the advantages of a third cabinet but operates independently of any opening mechanism.

FIG. 15A depicts an embodiment of the invention with two cabinets 36 and 14 in a closed operational state 1500 with rails 45 extended so that handle 46 is raised. Cover 52 of cabinet 36 is depicted closed.

FIG. 15B depicts a partially open operational state 1502 of the same embodiment of the invention with handle 36 lowered and cabinet 46 horizontally displaced with regard to cabinet 36. Displacement of cabinet 14 is optionally aided and/or controlled by slide mechanism 26 and 32 as described above.

FIG. 15C depicts a more fully open operational state 1504 of the same embodiment of the invention with cover 52 pivoted to an open position and supported by handle 46 as described above. In this view, an inner surface 1552 of cover 52 is visible.

Tray 1520 is also visible seated within an upper opening of cabinet 36. Optionally, a bottom side of tray 1520 is adapted to conform to complementary features on inner surface 1552 of cover 52.

FIG. 15D depicts a fully open operational state 1506 of the same embodiment of the invention with tray 1520 seated on inner surface 1552 of cover 52. This operational state is analogous to operational state 906 of FIG. 9D with tray 1520 corresponding to cabinet 110 and cabinets 32 and 14 corresponding to cabinets 108 and 102 respectively.

Exemplary Support Brace

In situations where a weight of items stored in tray 1520 is excessive, cover 52 may not be sufficiently supported by handle 46 as depicted in FIGS. 14 and 15.

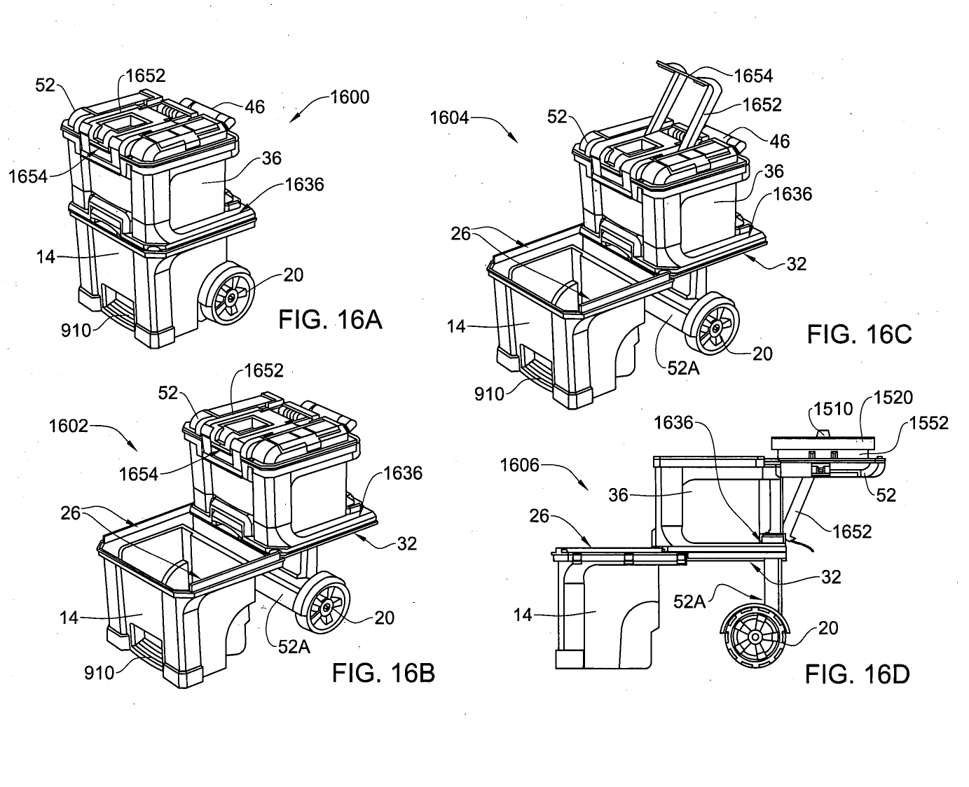

FIGS. 16A, 16B, 16C are perspective views depicting an exemplary embodiment of the invention including an optional folding support brace in operational states 1600, 1602 and 1604 respectively. FIG. 16D is a side view of a fully open operational state 1606.

FIG. 16A depicts an exemplary embodiment of the invention similar to that described above with regard to FIG. 15 in a closed operational state 1600. A folding support brace 1652 with a horizontal support 1654 is visible. Optionally, brace 1652 and support 1654 are seated in a groove on cover 52 and/or a front surface of cabinet 36. Optionally, seating of support brace 1652 and/or horizontal support 1654 in grooves serves as a closure mechanism for cover 52 of cabinet 36.

FIG. 16B depicts a partially open operational state 1602 in which cabinet 14 is horizontally displaced with respect to cabinet 36 as described hereinabove.

FIG. 16C depicts an operational state 1604 in which support brace 1652 and horizontal support 1654 have been lifted from their respective grooves.

FIG. 16D depicts an operational state 1604 in which cover 52 has been pivoted to a fully open position. Support brace 1652 is disposed between cover 52 and a rear portion of cabinet 36. In the depicted embodiment, horizontal support 1654 (not visible in this side view) is seated on shelf 1636 on a rear face of cabinet 36. Optional support 1654 serves to stabilize brace 1652 with respect to cabinet 36. Tray 1520 is shown positioned on inner surface 1552 of cover 52.

Exemplary Materials

According to various exemplary embodiments of the invention, various materials are employed in construction.

In some exemplary embodiments of the invention, use of plastics contributes to a reduction in overall weight of the cart. Suitable plastics include, but are not limited to, polyvinylchloride (PVC), polycarbonate, polyethylene and polystyrene. These exemplary lightweight materials can be employed in construction of various buckets, compartments, cabins and containers described hereinabove.

Alternatively or additionally, use of metals contributes to structural strength. Optionally, lightweight metals such as aluminum and/or aluminum alloys are employed. In some exemplary embodiments of the invention, lightweight metals can be used to construct one or more of rails 45, handle 46, portions of support bracket 52a and hubs of wheels 20.

Alternatively or additionally, heavier metals (e.g. steel or other iron based alloys) can be employed to impart increased strength to one or more weight bearing portions of the cart such as, for example, rails 45, portions of support bracket 52a and hubs of wheels 20 support legs 90 and/or 174.

One of ordinary skill in the art will be able to select appropriate materials for construction of various parts of the cart based upon anticipated loads.

General Description

In some exemplary embodiments of the invention, the portable containers assembly includes three or more containers (e.g. 102 108 and 110). Each of these containers includes sides, a bottom and an open upper face. Optionally, the sides and/or bottom can be provided as solid panels (as depicted in the figures) or mesh or grid or slat assemblies. In some exemplary embodiments of the invention, weight bearing slats or a weight bearing grid are covered by a lighter weight material (e.g. fabric or a thin plastic sheet). In some exemplary embodiments of the invention, this type of arrangement contributes to an overall reduction in weight wile preventing small items from falling out of the containers

In some exemplary embodiments of the invention, a locomotive assembly includes a wheeling assembly (e.g. 20+52a) and a handle assembly (e.g. 45+46) for locomoting the portable containers assembly.

In some exemplary embodiments of the invention, an operating mechanism adapted to reversibly alter an arrangement of the containers between at least two configurations is provided. Optionally, the configurations include a closed configuration (e.g. FIG. 11A) in which a bottom of a first container covers an open upper face of an adjacent second container below the first container.

Optionally, the configurations include an open configuration (e.g. FIG. 11C) in which said open upper face of each of said containers is not fully covered by a bottom of any other container.

In some exemplary embodiments of the invention, the operating mechanism includes a sliding mechanism (e.g. FIGS. 11 and 14) including a first slide member 26 fixed to a side edge of one of the containers (e.g. 102) and a second slide member 32 fixed to a corresponding side edge of an adjacent container (e.g. 108). Optionally, the first and second slide members are slidingly secured to one another.

In some exemplary embodiments of the invention, the operating mechanism includes at least two parallel arms (e.g. 1166 and 1168), each of said arms pivotally attached to at least two of said at least three containers. Optionally, at least one of the parallel arms (e.g. 1166) is pivotally attached to at least two non-adjacent containers (e.g. 102 and 110). In some exemplary embodiments of the invention, at least one parallel arm 1166 is adapted for axial translation with respect to at least one point of pivotal attachment 1184. Adaptation can be in the form of axial slot 1186 in arm 1166.

In some exemplary embodiments of the invention, the operating mechanism 1210 includes at least one pair of toothed drive wheels (e.g. 1310 and 1320) and a drive belt 1330 connecting first wheel 1310 to second wheel 1320. In the embodiment depicted in FIGS. 12 and 13, axial motion a first of the at least three containers (e.g. 102) causes teeth 1340 thereon to engage complementary teeth 1312 on first wheel 1310 which translates the axial motion of first container 102 to rotational motion of first wheel 1310 which is further translated to axial motion of drive belt 1330 which is further translated to rotational motion of second wheel 1320.

Referring again to FIG. 9, in some exemplary embodiments of the invention, the operating mechanism includes a first operating mechanism adapted to alter an arrangement of a first subset of said containers between said closed and said open configurations. Optionally, sliding mechanism 26 and 32 of containers 102 and 108 respectively and a second operating mechanism (e.g. arms 166 and 168) adapted to alter an arrangement of a second subset of the containers (e.g. 108 and 110) between the closed and open configurations.

Referring again to FIG. 11, in some exemplary embodiments of the invention, the operating mechanism includes a first operating mechanism (e.g. 26 and 28) and a second operating mechanism (e.g. 1166 and 1168) adapted to cooperatively alter an arrangement of at least two of the containers between the closed and the open configurations.

In the depicted embodiment of FIG. 11C, rails 45 and wheels 20 function as a support leg adapted to support at least container 108 in an open position. Optionally, openable cover 52 covers the open upper face uppermost container 110. Cover 52 is optionally articulated container 110. Optionally, at least one removable tray 1520 adapted to reside in at least one of the containers is provided.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1-50. (canceled)

51. A portable containers assembly comprising:
(a) a base cabinet in the form of a bucket having an upper end;
(b) a top case assembly comprising at least one top cabinet, and slidably secured to the base cabinet and slidable between a closed position in which it substantially covers said upper end, and an open position in which it exposes the base cabinet; and
(c) a locomotive assembly comprising a wheeling assembly and a handle assembly for locomoting the portable containers assembly.

52. A portable containers assembly according to claim 51, wherein the portable containers assembly further comprises at least one support leg for supporting the top case assembly at the open position.

53. A portable containers assembly according to claim 52, wherein the at least one support leg extends from a rear wall of the top case assembly and extends, at the open position thereof, to a surface supporting the portable containers assembly.

54. A portable containers assembly according to claim 51, wherein the handle assembly is deployable between at least a locomoting position and a ground support position in which it constitutes a support leg assembly.

55. A portable containers assembly according to claim 51, wherein the top case assembly comprises a tilt type cabinet.

56. A portable containers assembly according to claim 51, wherein the top case assembly further comprises at least one second compartment articulated to said at least one top cabinet via a parallelogram mechanism.

57. A portable containers assembly according to claim 56, wherein at least one arm of said parallelogram mechanism connects said at least one second compartment and said base cabinet.

58. A portable containers assembly according to claim 51, wherein the base cabinet comprises at a bottom portion thereof a foot step which when stepped on engages a ground surface supporting the portable containers assembly.

59. A portable containers assembly according to claim 51, wherein the top case assembly comprising a second cabinet slidingly articulated to a first top cabinet, said second cabinet slidable between a closed position in which it substantially covers a top edge of said first cabinet end, and an open position in which it exposes it.

60. A portable containers assembly comprising:
(a) at least three containers, each of said containers comprising sides, a bottom and an open upper face;
(b) a locomotive assembly comprising a wheeling assembly and a handle assembly for locomoting the portable containers assembly;
(c) an operating mechanism adapted to reversibly alter an arrangement of said containers between:
a closed configuration in which said bottom of a first container covers said open upper face of an adjacent second container below said first container; and
an open configuration in which said open upper face of each of said containers is not covered by a bottom of any other container.

61. A portable containers assembly according to claim 60, wherein said operating mechanism comprises a sliding mechanism comprising a first slide member fixed to a side edge of one of said containers and a second slide member fixed to a corresponding side edge of an adjacent container, said first and second slide members being slidingly secured to one another.

62. A portable containers assembly according to claim 60, wherein said operating mechanism comprises at least two parallel arms, each of said arms pivotally attached to at least two of said at least three containers.

63. A portable containers assembly according to claim 62, wherein at least one of said parallel arms is pivotally attached to at least two non-adjacent containers.

64. A portable containers assembly according to claim 62, wherein at least one of said parallel arms is adapted for axial translation with respect to at least one point of pivotal attachment.

65. A portable containers assembly according to claim 60, wherein said operating mechanism comprises at least one pair of toothed drive wheels and a drive belt connecting a first wheel of said pair to a second wheel of said pair;
wherein axial motion of a first of said at least three containers causes teeth thereon to engage complementary teeth on said first wheel which translates said axial motion of said first container to rotational motion of said first wheel which is further translated to axial motion of said drive belt which is further translated to rotational motion of said second wheel.

66. A portable containers assembly according to claim 60, wherein said operating mechanism comprises:
a first operating mechanism adapted to alter an arrangement of a first subset of said containers between said closed and said open configurations; and
a second operating mechanism adapted to alter an arrangement of a second subset of said containers between said closed and said open configurations.

67. A portable containers assembly according to claim 60, comprising at least one support leg adapted to support at least one of said containers in an open position.

68. A container assembly comprising;
a base container having an upper opening;
an upper container mounted in covering relation over said upper opening of said base container;
a linkage connecting said upper container to said base container in a manner that allows said upper container to be displaced from said covering relation over said upper opening of said base container, so as to permit access into said base container through said upper opening;
a support assembly spaced from the base container when the upper container is displaced from said covering relation over said upper opening of said base container;
wheels disposed toward a lower portion of said container assembly; and
a handle for rollingly transporting said container assembly on said wheels in a tilted configuration.

69. A container assembly according to claim 68, further comprising a top container mounted in covering relation over said upper container, wherein said linkage is connected to said top container in a manner that allows said top container to be displaced from said covering relation over said upper container.

70. A container assembly according to claim 68, wherein a topmost of said containers has a pivotable cover that can be moved to cover and uncover an upper opening in said topmost container.

71. A container assembly according to claim 68, wherein said wheels are mounted on the support assembly.

72. A container assembly according to claim 68, wherein said support assembly is operatively connected with said upper container so as to be automatically moved from a position adjacent to said base container to the position spaced from the base container when the upper container is displaced from said covering relation over said upper opening of said base container.

73. A container assembly according to claim 70, wherein the pivotable cover has an opening stop surface that engages a cooperating stop surface on the top container when the cover is pivoted to an open position, so that when pivoted to an open position, said cover is disposed in a horizontal, cantilevered position.
